(19) United States
(12) Patent Application Publication
(10) Pub. No.: US 2011/0143214 A1
(43) Pub. Date: Jun. 16, 2011

(54) ORGANIC ADDITIVES FOR IMPROVING PERFORMANCE OF LEAD-ACID BATTERIES

(75) Inventors: Boris Monahov, East Peoria, IL (US); Kurt Kelley, St. George, ME (US); Mohamadkheir Alkhateeb, Dunlap, IL (US)

(73) Assignee: FIREFLY INTERNATIONAL ENERGY GROUP, INC., Peoria, IL (US)

(21) Appl. No.: 13/054,144

(22) PCT Filed: Jul. 7, 2009
(86) PCT No.: PCT/US09/49785

§ 371 Date: Jan. 14, 2011

Related U.S. Application Data
(60) Provisional application No. 61/134,997, filed on Jul. 16, 2008.
(60) Provisional application No. 61/146,359, filed on Jan. 22, 2009.

(51) Int. Cl. H01M 10/08

(52) U.S. Cl. 429/324; 429/337; 429/338; 429/341; 429/344; 429/347

(57) ABSTRACT

The present invention includes small molecule organic additives for lead acid batteries, a lead acid battery and components thereof containing the small molecule organic additives of the invention, and methods for the use of such compounds. The batteries of the invention may optionally further contain carbon foam. The presence of carbon in the battery may generate some of the organic agents of the invention.

### CROSS-REFERENCE TO RELATED APPLICATIONS

This application claims priority from U.S. Provisional Patent Applications Nos. 61/134,997 filed Jul. 16, 2008 and 61/146,359 filed Jan. 22, 2009.

### FIELD OF THE INVENTION

This invention relates to lead-acid batteries and, more specifically, to batteries and components therefore containing novel materials for improving battery performance.

### BACKGROUND OF THE INVENTION

Lead acid batteries are constructed of positive and negative plates immersed in an electrolyte such as sulphuric acid. The plates are made of a lead grid encased in a paste to form the plate. Different curing techniques create plates that are either positive or negative.

When lead-acid batteries are charged, the cured paste of the positive plate is electrically driven to lead dioxide (PbO2) in a form that is generally crystalline with an amorphous margin, and the paste of the negative plate is converted to lead, also in crystalline form. Conversely, during subsequent discharge of the battery, the pastes of both positive and negative plates convert toward lead sulfate as the lead and lead dioxide crystals dissolve to generate current.

Inefficiencies resulting from solubility, diffusion, conductivity and crystallization effects during the use of the battery can cause degradation of the plate structure and loss of surface area, conductivity and rigidness. This degrades performance of the battery.

The accepted wisdom in the lead acid battery arts is that any additives to the sensitive lead acid reaction disadvantageously increase gassing, hydrolysis and displace active materials, all thereby degrading performance.

### SUMMARY OF THE INVENTION

The present invention includes small molecule organic additives for lead acid batteries, a lead acid battery and components thereof containing the small molecule organic additives of the invention, and methods for the use of such compounds. The batteries of the invention may optionally further contain carbon in the form of foam.

The additives of the invention reduce some inefficiencies and effects noted above, and thereby improve battery capacity and utilization efficiency.

The organic additives may be added directly to battery paste or electrolyte as a production step, or may be added to preexisting batteries. Carbon precursors may be constructed and arranged in a battery to advantageously promote generation of organic molecules.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION OF THE PREFERRED EMBODIMENTS

The following description of the preferred embodiment(s) is merely exemplary in nature and is in no way intended to limit the invention, its application, or uses.

The organic additives of the invention may be liquid, solid or gaseous organic compounds having small molecules with molecular weight smaller than 1000 and preferably smaller than 500.

The organic additives of the invention may be liquids and solids including but not limited to: formic acid, HCO2H, formate ions HCO2- or metal formates M-HCO2; carbonate or bicarbonate ions (CO32- and HCO3-), metal carbonates; formaldehyde; oxalic acid H2C2O4, oxalate and acid oxalate ions (C2O42- and HC2O4-), metal oxalates; acetic acid, CH3COOH; acetates, alcohols, such as R3C—OH; carboxyl compounds such as R3C—CO—OH.

They may include Carbonil compounds like aldehydes, R3C—CHO; ethers, R3C—O—CR3; ketones, R3C—CO—CR3; carboxylic acids, R—CO—OH; esters, R3C—CO—O—CR3; acid anhydride, R—CO—O—CO—R1; enones, RC(O)C(R1)CR2′R3; hydroperoxides, R3C—O—O—CR3; carbonate esters, R3C—O—CO—O—CR3; metal carbonyls, Me-(CO)n.

They may include solutions of CH4, CO2, HC and CO in water or sulfuric acid.

The organic additives of the may invention include compounds of these organics which may optionally contain lead and/or sulfur and/or oxygen and/or hydrogen as well as other organic groups and radicals.

The organic additives of the invention may include resins including for example Furfuryl.

Carbon containing gases including but not limited to methane, carbon monoxide and carbon dioxide which can be dissolved into the electrolyte may also be included.

The organic additives of the present invention do not include polymers, metal helates, mineral or synthetic oils or lignosulphonates.

Concentrations

The above mentioned compounds can be added in varying concentrations including but not limited to up to about 20%, and most optimally up to about 10%, as preliminary prepared chemicals to any lead-acid battery during its production (to the electrolyte or to the separator or to the active materials or to the box/lid). Varying combinations of organic additives and their weight percentage ratio can be used without departing from the scope of the invention.

The concentration of the additives can measure between some milligrams per liter and tens of grams in the added liquid, or between some milligrams and tens of grams per Amp hour (Ah) of nominal capacity.

Methods of Adding the Organics to the Battery

There are two general ways the organic compounds can be added to the battery: direct addition and inclusion in the battery of the chemical precursors of the organic additives.

### Embodiment 1

Direct Inclusion of Organic Additives

Liquid additives may be prepared preliminary and then added in three possible ways: a) adding to the paste during paste mixing (positive and/or negative paste) so that they are included in the Negative Active Material (NAM) and/or the Positive Active Material (PAM), b) adding to the electrolyte which is poured into the battery after assembly, c) adding to the electrolyte of ready batteries with liquid electrolyte (batteries of the so called “flooded” design).

Solid additives may be a) added to the paste during paste mixing (positive and/or negative paste, NAM and/or PAM), b) added to the electrolyte which is poured into the battery after assembly, or c) added to the electrolyte of existing batteries being preliminary dissolved in some water or electrolyte.

Gaseous additives Carbon containing gases including but not limited to methane, carbon monoxide and carbon dioxide which can be dissolved into the electrolyte may also be included. The sulfuric acid electrolyte may be purged with the above mentioned gases, and then poured into cells as a liquid additive.

Mechanism of Action

The organic additives of the invention are thought to influence the nucleation and crystal growth rates of lead, lead sulfate, lead dioxide, lead monoxides, minimum, basic lead sulfates and lead hydroxyl carbonate crystals in sulfuric acid water solutions (at concentrations of up to 50% by weight) as well as the ratio of amorphous to crystalline PbO2.

As a result the structure of the active materials in the lead-acid battery (and of paste if additives used for its production) is changed in a manner that improves battery performance.

Organic compounds absorb in at least small amounts on NAM crystals and perhaps on PAM particles and influence strongly the morphology and structure of NAM (expanders etc.).

The organic additives of the invention can change the kinetics of hydrogen and/or oxygen evolution in lead-acid batteries and hence improve the recombination efficiency of a battery of the invention.

In the positive active material contained in the positive plate the organic additives of the invention react with the hydrated gel zones of the PbO2 particles having the formula PbO(OH)2. As a result of this the hydrated zones become more stable and conductive providing high energy efficiency and longer cycle life to the active material. In the corrosion layer formed on the surface of the positive grid they can also react with the hydrated zones of PbO2 as well as with OH ions and radicals. The contact between the active material and the grid is reinforced, and its conductivity remains high for a longer time during the discharge process. The entire positive plate gains in PAM utilization and in cycle life.

In the negative active material contained in the negative plate they bond to the surface of Pb and/or PbSO4 crystals changing their surface energy, nucleation and crystal growth rate. As a result, the NAM spongy structure becomes more regular, its pore size and distribution increases along with the active surface area. In this way the energy performance of the negative plate is increased.

### Results

The organic additives can be used in any type of lead-acid batteries with or without carbon foam.

Performance levels of pre-existing batteries may also be improved by the additives.

The additives will improve battery performance parameters like power, energy output, capacity, utilization efficiency and cycleability, beginning during the first charge and discharge of the battery. The additives may maintain steady on-going performance levels higher than those maintained without the additives.

### Example 1

Six organic additives were prepared for direct addition to a battery;

1. Acetic acid, obtained from Sigma Aldrich, 99.7% ACS reagent.

2. Acetone, obtained from Fisher Scientific, HPLC grade, meets ACS specifications, 0.2 micrometer sieved.

3. Ethanol, obtained from Acros organics, ACS, 190 proof, 95%.

4. Formaldehyde obtained from Alfa Aesar, 37% in aq. solution, ACS, 36.5-38.0%, stabilized with 10-15% methanol.

5. Isopropanol, obtained from Acros Organics, HPLC grade, 99.9%.

6. Methanol, obtained from Fisher Scientific, HPLC grade, meets ACS specifications.

Procedure of Adding:

Six lead acid battery cells were selected for the experiment. The cells were 2V 145 Ah each, flooded type. The cells were produced about 1 year ago. Before the experiment they were used for about 6 months, after that they spent another six months on the shelf loosing part of their capacity due to self discharge and sulfation. The capacity was 109 Ah (i.e. 75% of the nominal value).

In order to restore the capacity loss 19 full charge-discharge cycles (C/2 discharge rate, 100% discharge) were performed. As a result the capacity increased up to 134 Ah (92% of the nominal value), tending to stabilize. The capacity restoring cycling for two cells before adding the additives is shown in table 1 below.

During the next cycle 15 ml of each liquid additive was injected into one of the battery cells. Each cell contained about 2.2 liters of electrolyte. This happened during the open circuit rest period, before the discharge step. No stirring or barbutation was used. After injecting the additives the cells were closed again and after one more hour of rest they continued cycling beginning with the discharge step. Thirty two full 100% discharge, charge-discharge cycles (C/5 discharge rate) were preformed after the addition.

Impact of the Additives on Cell Capacity

After adding the additives the capacity increased, reached and even exceeded the nominal capacity value by 5.5% (Table 2). In some cells there was variability during the first and the second cycle, which are probably due to variable initial mixing of the additive with the electrolyte. The purging action of gases evolved at the end of charge did the necessary stirring, The beneficial action is seen in table 2 below showing the cycling curves of the cells after they got the additives.

After this test the cells were left at open circuit for self discharge tests.

Separately, adding 2 ml per liter oxalic acid was found to improve the cycling performance of a cell.

1. A lead acid battery having a paste or an electrolyte containing organic additives comprising:
a lead acid battery battery comprising an electrode, a paste and an electrolyte;
at least one of said paste or said electrolyte containing organic additives having a molecular weight smaller than about 100 u.

2. The battery of claim 1 wherein said organic additives have a molecular weight smaller than about 500 u.

3. A lead acid battery having an electrode material, a lead paste, a current collector, a separator, an electrolyte and a box wherein at least one of said lead paste, said separator and said electrolyte contain organic additives comprising carbonil compounds.

4. The battery of claim 3 wherein said carbonil compounds are selected from the group consisting of: aldehydes, R3C—CHO; ethers, R3C—O—CR3; ketones, R3C—CO—CR3; carboxylic acids, R—CO—OH; esters, R3C—CO—O—CR3; acid anhydride, R—CO—O—CO—R1; enones, RC(O)C(R1)CR2′R3; hydroperoxides, R3C—O—O—CR3; carbonate esters, R3C—O—CO—O—CR3; metal carbonyls, Me-(CO)n.

5. A lead acid battery having an electrode material, a lead paste, a current collector, a separator, an electrolyte and a box wherein at least one of said lead paste, said separator and said electrolyte contain organic additives comprising liquids and solids including: formic acid, HCO2H, formate ions HCO2- or metal formates M-HCO2; carbonate or bicarbonate ions (CO32- and HCO3-), metal carbonates; formaldehyde; oxalic acid H2C2O4, oxalate and acid oxalate ions (C2O42- and HC2O4-), metal oxalates; acetic acid, CH3COOH; acetates, alcohols, such as R3C—OH; carboxyl compounds such as R3C—CO—OH.

6. The battery of claim 1 wherein said organic additives are selected from the group consisting of solutions of CH4, CO2, HC and CO in water or sulfuric acid.

7. The battery of claim 1 wherein organic additives are further comprised of lead and/or sulfur and/or oxygen and/or hydrogen as well as other organic groups and radicals.

8. The battery of claim 1 wherein said organic additives are selected from the group consisting of carbon containing gases including methane, carbon monoxide and carbon dioxide that can be dissolved into the electrolyte.

9. The battery of claim 1 wherein the battery is a carbon foam battery.

10. The battery of claim 1 wherein said organic additives are added to one or more of the following components: lead paste, current collectors, separators, electrolyte, box, positive active material and negative active material.

11. The battery of claim 1 wherein the additives are one or more of the following: formic acid, formaldehyde, oxalic acid, acetic acid, compounds of these organics which may optionally contain lead and/or sulfur and/or oxygen and/or hydrogen, as well as other organic groups and radicals; carbon containing gases including methane, carbon monoxide and carbon dioxide that can be dissolved into the electrolyte.

12. The battery of claim 1 wherein the additives are resins.

13. The battery of claim 1 wherein the additives are Furfuryl.

14. A method of enhancing performance of a lead acid battery by adding to an electrolyte or a paste of the battery during or after construction organic additives, said addition of organic additives comprising:
providing a lead acid battery having an electrode material, a lead paste, a current collector, a separator, an electrolyte and a box;
forming an organic additive comprised of material having a molecular weight of less than about 500 u; and
adding said organic additive to at least one of said lead paste, said separator, and said electrolyte.
